(19) United States
(12) Patent Application Publication
(10) Pub. No.: US 2025/0269431 A1
(43) Pub. Date: Aug. 28, 2025

(54) SCAN PARAMETERS AND PROCESS MONITORING FOR POWDER BED FUSION FROM CALIBRATED MELT POOL MODEL

(71) Applicant: RENISHAW PLC, Wotton-under-Edge, Gloucestershire (GB)

(72) Inventors: Andrew John MOORE, Riccarton (GB); Alexander John ROSS, Riccarton (GB); Ioannis BITHARAS, Riccarton (GB); Kyle Graham PERKINS, Riccarton (GB)

(73) Assignee: RENISHAW PLC, Wotton-under-Edge, Gloucestershire (GB)

(21) Appl. No.: 18/857,550

(22) PCT Filed: Apr. 20, 2023
(86) PCT No.: PCT/EP2023/060362

§ 371 Date: Oct. 17, 2024

(30) Foreign Application Priority Data
Apr. 22, 2022 (GB) 2205845.7

(51) Int. Cl. B22F 10/366; B22F 10/28; B22F 10/85; B22F 12/49; B33Y 10/00; B33Y 50/02

(52) U.S. Cl. CPC B22F 10/366; B22F 10/28; B22F 10/85; B22F 12/49; B33Y 10/00; B33Y 50/02

(57) ABSTRACT

A method of generating scan parameters for a powder bed fusion additive manufacturing process, including receiving at least one desired property of a material modified zone formed by melting material and/or changing a microstructure of the material through exposure of a powder bed to an energy beam, and determining the scan parameters for the energy beam estimated by a powder bed fusion model to result in a material modified zone having a property corresponding to the at least one desired property.

### FIELD OF INVENTION

This invention concerns improvements in or relating to powder bed fusion and, in particular, to modelling a powder bed fusion process. The modelling may be used in a process for generating scan parameters for a powder bed fusion process or for characterising or validating a powder bed fusion process. The powder bed fusion process may be characterised by temperatures in a material modified zone formed by melting material and/or changing a microstructure of the material through an exposure of a powder bed to an energy beam. The powder bed fusion process may be characterised by shapes, such as depths, widths and/or lengths of the material modified zone. The model may be used to predict a property of the material modified zone, such as a melt pool, generated by an energy beam exposure based on input parameters, such as scan parameters.

### BACKGROUND

Powder bed fusion is an additive manufacturing (AM) process that can build metal parts layer-by-layer by selectively fusing regions of a powder bed with an energy beam, such as a laser or electron beam. Considerable research is being undertaken into numerical simulations of the process.

S. A. Khairallah, A. T. Anderson, A. Rubenchik, W. E. King, “Laser powder-bed fusion additive manufacturing: Physics of complex melt flow and formation mechanism of pores, spatter and denudation zones”, Acta Materialia, 108 36-45 (2016) discloses meso-scale, multi-physics numerical models describing the interaction of the heat source with the substrate and powder layer, incorporating temperature-dependent properties (e.g. viscosity, surface tension) and effects (e.g. vapour pressure and buoyancy forces) in the molten metal. Such models are computationally intensive and are currently limited to single laser scan tracks of a few millimetres in length. However, they provide a useful insight into the coupled physical phenomena and mechanisms for pore and spatter production. X. Li, C. Zhao, T. Sun and W. Tan, “Revealing transient powder-gas interaction in laser powder bed fusion process through multi-physics modeling and high-speed synchrotron x-ray imaging”, Additive Manufacturing 35 101362 (2020) and Y. A. Mayi, M. Dal, P. Peyre, M. Bellet, C. Metton, C. Moriconi and R. Fabbro, “Laser-induced plume investigated by finite element modelling and scaling of particle entrainment in laser powder bed fusion”, Journal of Physics D-Applied Physics 53 (7) 075306 (2020) extend the meso-scale models to couple the incompressible condensed phase (solid and liquid metal) with the compressible gaseous phase (vapor metal and protection gas) to study denudation due to the motion of individual powder particles, but only for laser-spot illumination to date.

Introducing simplifying assumptions to the underlying physics in a numerical model means that detailed effects such as spatter production are excluded but resolving the models is computationally less intensive.

C. Bruna-Rosso, A. G. Demir and B. Previtali, “Selective laser melting finite element modeling: Validation with high-speed imaging and lack of fusion defects prediction”, Materials & Design 156 143-153 (2018) discloses use of a volumetric source for modelling powder bed fusion. The volumetric heat source was experimentally calibrated from micrographs of the melt pool cross-section and images of the top surface for the melt pool length. The range of laser powers and scan speeds restricted the melt pools to the conduction mode, for which the volumetric source is not most advantageous.

E. J. Schwalbach, S. P. Donegan, M. G. Chapman, K. J. Chaput, M. A. Groeber, A discrete source model of powder bed fusion additive manufacturing thermal history, Additive Manufacturing 25 485-498 (2019) calibrated a volumetric source used to model powder bed fusion that included a depth component in proportion to the depth-to-width aspect ratio of the melt pool. The fit was conducted only at the centre of a relatively narrow range of laser power and scan speed process settings and no consideration was given to the length of the source.

### SUMMARY OF INVENTION

According to a first aspect of the invention there is provided a method of generating scan parameters for a powder bed fusion additive manufacturing process, the method comprising receiving at least one desired property of a material modified zone, the material modified zone formed by melting material and/or changing a microstructure of the material through an exposure of a powder bed to an energy beam, and determining scan parameters for the energy beam estimated by a powder bed fusion model to result in a material modified zone having a property corresponding to the at least one desired property.

In this way, rather than selecting a set of scan parameters, the user sets a desired outcome (property) for the material modified zone method and the scan parameters are derived therefrom. The desired property may be a non-transient property of the material modified zone that remains after the material modified zone has solidified. For example, a mechanical property, such as a microstructure, grain orientation or residual stress; or a geometric property, such as a dimension of the material modified zone. Alternatively, the desired property may be a transient property, preferably spatial, transient property, of the material modified zone that only exists during formation of the melt pool. For example, a thermal property, such as a temperature distribution across the material modified zone, a temperature isosurface, a spatial or temporal temperature gradient or cooling rate of the material modified zone. The property may be a mode of melting (conduction, transition or keyhole mode) to form the material modified zone. The energy required to achieve the desired property may differ in different regions of a part being built due to the conduction of heat through the object being dependent on a geometry of the part. Therefore, even if the desired property is the same for different exposures, different scan parameters may be determined for these different exposures. The property is a temperature or correlates with a temperature achieved during the fusion process.

A property corresponding to the at least one desired property may be a property that correlates with or matches the desired property. As such, the property of the material modified zone is selected or determined based on the desired property.

The method may comprise determining a spatial distribution of temperatures from the desired property of the material modified zone and resolving the model for the spatial distribution of temperatures to determine the scan parameters.

The material modified zone may be a fusion zone (zone of melted material, e.g. the melt pool) and/or a heat affected zone (HAZ). The heat affected zone is an area of solidified material, for example solid material formed from melting powder with a previous exposure, that is not melted by the exposure but which undergoes changes in microstructure as a result of heating of the solidified material caused by the exposure. The material modified zone may be a zone defined by a phase transition boundary in the heat affected zone or the fusion zone. The material modified zone may be a zone defined by solidus and/or liquidus boundaries.

The desired property may be a dimension of the material modified zone (such as depth, width and/or length) and the method generates scan parameters predicted to result in such a dimension of the material modified zone. In one embodiment, the at least one desired dimension is melt pool depth and melt pool length. Melt pool width may be derived from another parameter, such as the melt pool depth (for example, based on a desired melt pool depth to width ratio) or an energy beam spot diameter, such as 1/e² spot diameter.

The method may comprise determining the scan parameters estimated by a powder bed fusion model to result in a melt pool in a transition mode. It will be understood that “conduction mode” as used herein means that the energy of the energy beam is coupled into the powder bed primarily through heat conduction creating a melt pool having a width greater than its depth. This is to be contrasted with keyhole mode in which a hole is formed in the melt pool where material is vaporised by exposure to the energy beam. A melt pool formed in keyhole mode has a deep, narrow profile with a ratio of depth to width of greater than 1.5. A transition mode exists between the conduction mode and the keyhole mode, wherein the energy does not dissipate quickly enough and the processing temperature rises above the vaporisation temperature. A depth of the melt pool increases and penetration of the melt pool can start. A melt pool in the transition mode typically has a depth to width ratio of more than 0.5 but less than 1.5.

The powder bed fusion model may comprise a look-up table or function that associates the at least one desired property to one or more scan parameters. The look-up table or function may comprise or define intermediate values extrapolated from measured melt pool properties for known scan parameters (e.g. the model has been calibrated based on experimental data or numerical data generated from meso-scale, multi-physics numerical models and the intermediate values extrapolated therefrom). The look-up table or function may define a relationship between the at least one desired property and a scan parameter. The look-up table or function may associate the desired property to the energy density, power density, energy beam power and/or scan speed. The look-up table or function may associate the desired property to different scan parameters based on an initial temperature of the material.

The energy density, E, may be related to the power density, Ø, and scan speed or equivalent scan speed, v, of the energy beam by:

$$E = \frac{∅}{v}$$

An equivalent scan speed may be determined for scans defined as a plurality of point exposures (typically defined by a point distance and exposure time (and optionally a jump delay) rather than a scan speed). The powder density, Ø, may related to laser power, q and energy beam spot diameter, d, by:

$$∅ = \frac{4 q}{{d}^{2}}$$

Accordingly, scan parameters of scan speed, point distance, point exposure time, energy beam power and/or energy beam spot diameter/size can be determined from an energy beam density determined from resolving the model for the desired dimension. The scan parameters may comprise hatch distance. The scan parameters may comprise a cycle frequency for a cyclical scan path that loops back to cross over itself, such as a prolate trochoidal scan path.

The powder bed fusion model may be a heat conduction model. The powder bed fusion model may be a heat conduction-only model, wherein thermal transport due to radiation, evaporation and convection in the melt pool is ignored. This simplification assumes conduction dominates heat removal from the material modified zone and may assume that the calculated temperature in the solid material up to the boundary of the material modified zone is sufficiently accurate for the powder bed fusion model. The powder bed fusion model may be a finite difference, finite volume of finite element model. The powder bed fusion model may model the latent heat of fusion and/or temperature dependent properties of the material being fused/that undergoes a change in microstructure.

The powder bed fusion model may take into account an initial temperature of the powder when exposed to the energy beam. The powder bed fusion model may determine the initial temperature for each exposure point based on a location and time of previous exposures of the powder to the energy beam. The estimated energy density required to achieve the desired property of the material modified zone will change with different initial temperatures at the point of exposure. The powder bed fusion model may determine the initial temperature based on a geometry of a part being built. For example, a rate of cooling of an exposure point may vary depending on whether the exposure point is adjacent to and/or above solidified material or powder. The initial temperature may be calculated based on where the exposure is in a scan path, such as a hatch line, (at a beginning portion, middle portion or end portion of a scan path) and/or whether the exposure is carried out adjacent to another scan path, such as a hatch line, and/or whether powder melted by the exposure is above solidified material or powder. The initial temperature may be determined from a width of solidified material adjacent to the exposure and/or a thickness of solidified material below the exposure. The initial temperature may be determined using a sensor that measures temperatures of the powder bed and/or solidified material. For example, the sensor may be an infra-red sensor, such as an IR camera. Accordingly, the method may comprise receiving a geometric definition of a part and generating the scan parameters based on the received geometric definition.

Resolving the powder bed fusion model may comprise using an equivalent volumetric heat source having dimensions corresponding to the at least one desired dimension of the material modified zone to estimate a heat input that would give such a volumetric heat source. From the estimated heat input, the scan parameters can be determined. For example, resolving the powder bed fusion model may comprise using the equivalent volumetric heat source having dimensions corresponding to the at least one desired dimension to estimate a required energy density.

The method may comprise receiving thermal properties of a material from which a part is to be built using the powder bed fusion additive manufacturing process and using the thermal properties to resolve of the powder bed fusion model. The method may comprise receiving an identification of a material and retrieving from memory the thermal properties of the material.

The method may generate scan parameters that vary between exposure points along a scan path. In this way, the scan parameters are different to conventional scan parameters that are usually fixed for a scan path.

The steps of the first aspect described above may be computer-implemented.

According to a second aspect of the invention there is provided a method of manufacturing a part comprising building the part using powder bed fusion with scan parameters determined using a method according to the first aspect of the invention.

According to a third aspect of the invention there is provided a data carrier having instruction thereon, wherein when the instructions are executed by a processor of a powder bed fusion additive manufacturing apparatus, the processor is caused to control the powder bed fusion additive manufacturing apparatus to carry out the method of the second aspect of the invention

According to a fourth aspect of the invention there is provided a method of generating a look-up table or function for use in the first aspect of the invention comprising receiving, for each of a plurality of material modified zones formed by melting material and/or changing a microstructure of the material through exposures of material to an energy beam, a measured or numerically calculated property of the material modified zone, each material modified zone generated using a different set of scan parameters; calibrating parameters of a powder bed fusion model using the measured or numerically calculated properties to provide a calibrated powder bed fusion model; and generating the look-up table or function based on the calibrated powder bed fusion model.

The property of the material modified zone may be geometric property, such as a dimension, of the material modified zone. The material modified zone may be a zone defined by a phase transition boundary in a heat affected zone or a fusion zone. As such, the material modified zone may represent a measurement of a zone within which the temperature rises above a phase transition temperature, such as above a melting point temperature (solidus temperature or liquidus temperature) or above a temperature that causes grain refinement, due to the exposure. Accordingly, the method may comprise extracting a spatial distribution of temperature measurements from dimensions of a material modified zone.

The property may be measured during the melting process using a sensor. For example, the property may comprise temperatures (or values, such as mean values, derived from temperatures) measured across a material modified zone(s) using a sensor, such as an infra-red imaging sensor. For example, an infra-red imaging sensor may be capable of measuring temperatures of a top surface of the melt pool. Alternatively, the property may comprise a dimension (or values, such as mean values, derived from dimensions) of the material modified zone measured using an imaging sensor, such as a camera, or inferred from measurements of another property of the melting process. For example, a mode of melting and therefore, a shape of the melt pool, may be determined from measuring turbulence of a plasma plume generated such as disclosed in PCT/GB2022/050677, which is incorporated herein in its entirety by reference.

The method may use an inverse heat conduction problem (IHCP) approach to calibrate the powder bed fusion model. An advantage of the IHCP approach is that it enables systematic calibration of the powder bed fusion model. Physical effects that are computationally expensive to model, such as absorption of heat from the real source and Marangoni convection in the melt pool, may be implicitly incorporated into the powder bed fusion model. The parameters of the powder bed fusion model may describe an equivalent heat source used in the powder bed fusion model to represent a region having temperatures above a phase transition temperature as determined from the measured or calculated value for the material modified zone. With a set functional form of the equivalent heat source, the IHCP method is reduced to estimating the limited number of parameters that describe the equivalent heat source.

The equivalent heat source may comprise a volumetric heat source. The volumetric heat source may be defined by segments of two curved three-dimensional shapes. The two curved three-dimensional shapes may comprise no vertices or edges. The equivalent volumetric heat source may comprise a front segment modelling a front of the melt pool in a scan direction and a rear segment modelling a rear of the melt pool in the scan direction. The front segment may comprise a planar top face, a planar rear face and a continuous curved front face extending from an edge of the planar top face to an edge of the planar rear face. The rear segment may comprise a planar top face, a planar front face and a continuous curved rear face extending from an edge of the planar top face to an edge of the planar front face. The rear face of the front segment and the front face of the rear segment may be coincident. The curved faces of the two segments may be non-continuous at a boundary between the two segments (where the rear face of the front segment and the front face of the rear segment are coincident). By allowing for a discontinuity at the boundary between the two segments, a length of the rear segment can be increased without distributing an increased proportion of the energy beam power into the rear segment, which decreases penetration of the front segment. It is believed this more accurately reproduces the penetration observed experimentally in powder bed fusion. The two segments will typically be different, for example having different lengths, widths and/or depths.

The equivalent volumetric heat source may comprise a double-ellipsoid volumetric heat source. The term “double-ellipsoid volumetric heat source” as used herein means a volume defined by segments of two ellipsoids.

The equivalent heat source may comprise a combination of the volumetric heat source with a point and/or a line heat source.

Generating the look-up table or function may comprise using the calibrated powder bed fusion model to interpolate from the measured or numerically calculated property, scan parameters that generate material modified zones having intermediate properties. The property may be depth of the equivalent heat source. Additionally or alternatively, the property may be absorptivity of the equivalent heat source. Further additionally or alternatively, the property may be length of the equivalent heat source. The length of the equivalent heat source may be length of a rear segment of the equivalent heat source to a front segment of equivalent heat source. The look-up table or function may associate the property of the material modified zone to energy densities or power densities of the energy beam used in the powder bed fusion additive manufacturing process.

The steps of the fourth aspect described above may be computer-implemented.

The method may comprise melting material at different points in a powder bed or on a substrate using the different sets of scan parameters. The method may comprise measuring a property of the subsequently solidified material at the different points.

According to a fifth aspect of the invention there is provided a method of checking a powder bed fusion process or a powder bed fusion apparatus that carries out the powder bed fusion process comprising receiving a measured property of a material modified zone formed by melting material and/or changing a microstructure of the material through exposures of material to an energy beam and determining whether the powder bed fusion process or a powder bed fusion apparatus has changed by comparing the measured property to a property predicted by a powder bed fusion model calibrated using measurements obtained from a previous powder bed fusion process.

For example, the powder bed fusion model may be calibrated using melt pool measurements taken from material previously solidified by the powder bed fusion apparatus. If dimensions of the melt pools generated during a later powder bed fusion process differ from the dimensions predicted by the calibrated powder bed fusion model outside of an acceptable range, this may indicate that the conditions generated by the powder bed fusion apparatus have drifted by an unacceptable amount. The method may comprise generating an alert if the difference is outside of the acceptable range.

The powder bed fusion model may be calibrated for the powder bed fusion apparatus. For example, the coupling of the laser beam into the powder may differ for different powder bed fusion apparatus and therefore, the powder bed fusion model may need to be calibrated separately for different machines. Changes in a measured melt pool dimension at a later date from a melt pool dimension predicted by the powder bed fusion model may indicate a change or drift in the powder bed fusion machine or process.

The powder bed fusion model may be in accordance with the powder bed fusion model described with respect of the other aspects of the invention.

According to a sixth aspect of the invention there is provided a data carrier having instruction thereon, wherein when the instructions are executed by a processor, the processor is caused to carry out the method of the first, fourth of fifth aspect of the invention.

According to a seventh aspect of the invention there is provided apparatus comprising a processor arranged to carry out the method of the first, fourth of fifth aspect of the invention.

The data carrier of any of the aspects of the invention may be a suitable medium for providing a machine with instructions such as non-transient data carrier, for example a floppy disk, a CD ROM, a DVD ROM/RAM (including-R/-RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example signals sent over a wired or wireless network (such as an Internet download, an FTP transfer, or the like).

### DESCRIPTION OF THE DRAWINGS

FIG. 1 is a schematic of apparatus according to an embodiment of the invention;

FIG. 2 shows a double ellipsoid volumetric heat source, given by equation (1), for σₓ₁=σ_{y}, σₓ₂=4σₓ₁ and σ_{z}=3σₓ₁. (a) r₁=0.6, resulting in r₁/σₓ₁>r₂/σₓ₂. (b) Source continuity on the plane x=0, requiring r₁/σₓ₁=r₂/σₓ₂;

FIG. 3 shows a temperature distribution (in K) around the heat source for: (a) The volumetric heat source of FIG. 2(a) with a laser spot diameter d=4σ_{y}=50 μm; (b) A point heat with source with d=0 μm; (c) Difference (in K) between the temperature of FIG. 3(b) calculated by numerical integration and the analytic solution of equation (7);

FIG. 4 shows melt pool solidification boundaries obtained from the micrographs for the single-track experiments. This is a composite image: the tracks were spaced 1 mm apart on the substrate;

FIG. 5 is an example of the objective function, F(η, 2σ_{z}, 2σₓ₂), calculated for the case v=0.8 m/s from the single-track experiments of FIG. 4. (a), the objective function plotted over a range of the three parameters describing the double ellipsoid heat source, where η is the absorptivity, 2σ_{z} is the depth, and σₓ₂/σₓ₁ is the length of the rear ellipsoid with respect to the front ellipsoid. The identified minimum is at η=0.73, 2σ_{z}=93 μm and σₓ₂/σₓ₂=8.85. (b)-(d) The objective function on the planes passing through the minimum shown in (a), where ‘X’ indicates the fitted minimum in each plane;

FIG. 6 shows fitted parameters describing the volumetric heat source for the single-track experiments. (a) Absorptivity, η; (b) Depth, 2σ_{z}; and (c) Length of the rear ellipsoid with respect to the front ellipsoid, σₓ₂/σₓ₁;

FIG. 7 shows a temperature distribution (in K) around the volumetric heat sources fitted to the single-track experimental melt pool boundaries for: (a) 0.7 m/s; (b) 1.0 m/s; (c) 1.4 m/s; and (d) 1.8 m/s. The experimental melt pool boundary points taken from FIG. 4 and used in the fit are included as white points in the Front view. The target melt pool length used in the fit is indicated by a white circle in the side view;

FIG. 8 are examples of island scan micrographs: (a) Substrate only at 200 W and 1.0 m/s; (d) With powder at 200 W and 0.8 m/s. Calculated temperature distribution from the fitted volumetric heat source: (b) and (d) correspond to (a) and (c) respectively, using the same temperature scale as FIG. 7 and the melt pool solidification boundary at T=Tₘ as a white line;

FIG. 9 shows island scan results for the substrate only at the laser power and scan speeds indicated. The micrograph for the first track of each island is shown in the left half of each image. The right half of each image shows the melt pool boundary points taken from the micrograph, reflected in the line y=0, as white points. It also shows the calculated temperature distribution from the fitted volumetric heat source in each case, using the same temperature scale as FIG. 7 and the melt pool solidification boundary at T=Tₘ as a white line;

FIG. 10 shows island scan results with powder layer at the laser power and scan speeds indicated. The micrograph for the first track of each island is shown in the left half of each image. The right half of each image shows the melt pool boundary points taken from the micrograph, reflected in the line y=0, as white points. It also shows the calculated temperature distribution from the fitted volumetric heat source in each case, using the same temperature scale as FIG. 7 and the melt pool solidification boundary at T=Tₘ as a white line;

FIG. 11 shows fitted parameters describing the volumetric heat source for the island scan experiments. (a) Absorptivity, η; (b) Depth, 2σ_{z}; (c) and (d) Length of the rear ellipsoid with respect to the front ellipsoid, σₓ₂/σₓ₁. Fitted heat source parameters for the single-track experiments are also included. Material properties used for Ti-6Al-4V: α=9.44×10⁻⁶ m²/s, k=32.67 W/(m K) and Tₘ=1970 K. The legend shown in (b) is the same for all the graphs;

FIG. 12 shows energy density plotted against experimental melt pool depth for all results. The Ti-6Al-4V results were calculated from the melt pool depth in reference J. J. S. Dilip, S Zhang, C. Teng, K. Zeng, C. Robinson, D. Pal and B. Stucker, “Influence of processing parameters on the evolution of melt pool, porosity, and microstructures in Ti-6Al-4V alloy parts fabricated by selective laser melting”, Progress in Additive Manufacturing 2 157-167 (2017);

FIG. 13a is a graph of experimentally measured melt pool depths from adjacent tracks (hatch lines) in an island scan plotted against distance from an edge of the island where the first track was formed for different scan parameters; FIG. 13b is an initial temperature of the powder bed at the point of exposure for the island scan predicted by a heat accumulation model for different scan parameters; and FIG. 13c is a relationship between predicted initial temperature of the powder bed and resulting melt pool depth to be used in a look-up table or function for different scan parameters; and

FIG. 14 is a schematic diagram of an island and hatch lines illustrating the distance y.

### DESCRIPTION OF EMBODIMENTS

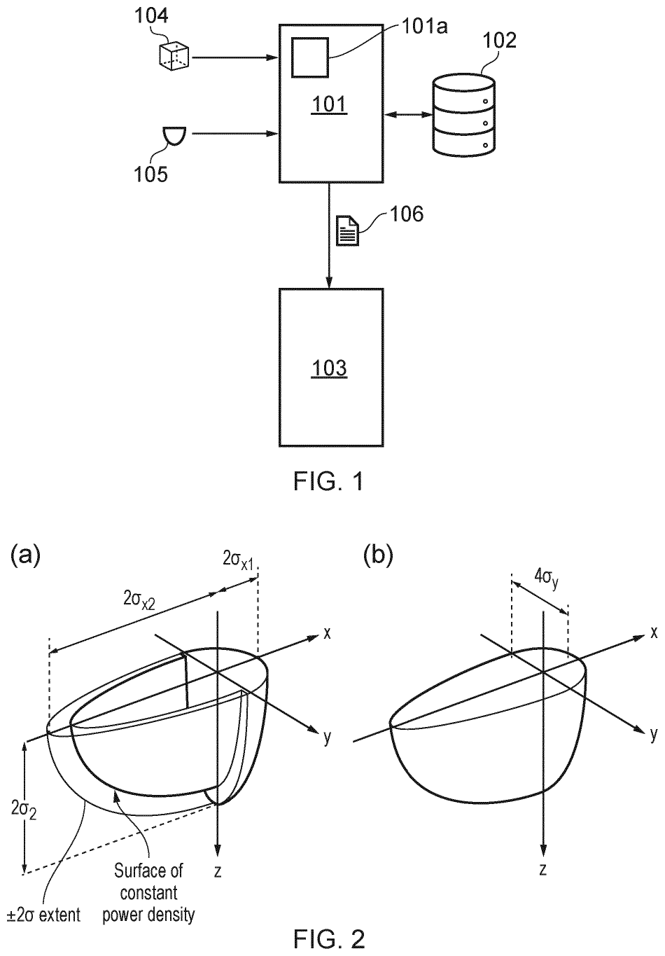

Referring to FIG. 1, the apparatus comprises a computer 101 comprising memory 102. The computer is arranged to receive a geometric definition 104 of a part to be built using a powder bed fusion apparatus, for example in the form of an STL or CAD file, and at least one desired property 105 of a material modified zone formed by melting material and/or changing a microstructure of the material through an exposure of a powder bed to an energy beam. In this embodiment the property is a melt pool dimension 105. Stored in memory of the computer 101 is a computer programme that causes the processor 101a of computer 101 to generate scan parameters for a powder bed fusion process for building the part based on the received geometric definition of the part and the at least one desired melt pool dimension 105, such as width, depth, length and/or a width to depth ratio. The melt pool dimension may be specified directly by the user or may be specified through reference to a desired microstructure for the part or melt pool mode (conduction, transition or keyhole mode). For example, certain melt pool shapes and geometric arrangements of melt pools may result in particular microstructures, such as described in WO2020/249932 and WO2021/234368 which are incorporated herein in their entirety by reference. The melt pool dimension may specify a range of acceptable melt pool dimensions. The inputs may also include identification of a material from which the part is to be built, the computer programme arranged to cause the processor to retrieve from the memory 102 thermal properties of the material stored therein, and/or the user may identify the properties of the material. In this embodiment, the thermal properties of the material are thermal conductivity, thermal diffusivity and melting temperature of the material.

The computer programme is arranged to generate scan parameters for building the part predicted by a powder bed fusion model to result in melt pool dimensions matching the at least one desired melt pool dimension 105. The powder bed fusion model used in this embodiment is a conduction-only model using a volumetric heat source calibrated based on experimental results as described below.

The computer 101 generates a build file 106 including the scan parameters and this build file 106 is sent to a powder bed fusion additive manufacturing apparatus 103. The powder bed fusion additive manufacturing apparatus 103 can then be caused to carry out a build of the part in accordance with the instructions of the build file 106. The computer 101, memory 102 and powder bed fusion additive manufacturing apparatus 103 can be located locally or remotely from each other.

### The Powder Bed Fusion Model

A direct heat conduction problem uses known heat input parameters (such as the laser power, scan speed and spot diameter) and material thermal properties to calculate the temperature distribution. The powder bed fusion model of this embodiment considers the reverse direction: it uses a temperature distribution (referred to herein as an equivalent heat source), such as a measured or desired melt pool dimension, to estimate either the heat input for known thermal properties, or to estimate thermal properties for a known heat input; referred to as an inverse heat conduction problem (IHCP).

An advantage of the IHCP approach is that physical effects that are computationally expensive to model, such as absorption of heat from the real source and Marangoni convection in the melt pool, are implicitly incorporated into the equivalent heat source. If an assumption is made on the functional form of the heat source (the equivalent heat source that represents the melt pool), the IHCP method can be reduced to estimating the limited number of parameters that describe it. Minimisation of the objective function defining the functional form of the heat source becomes a least-squares fit to an over-determined system of equations.

In this embodiment, the double-ellipsoid volumetric heat source proposed by J. Goldak, A. Chakravarti and M. Bibby, “A new finite-element model for welding heat-sources”, Metallurgical Transactions B—Process Metallurgy 15 (2) 299-305 (1984) is used as the functional form of the equivalent heat source. It is believed that the double-ellipsoid volumetric heat source represents the increased penetration at the front of the melt pool due to the vapour depression for powder bed fusion.

The power density Q (in W/m3) of the double-ellipsoid volumetric heat source is given by equation (1) and shown in FIG. 2.

$${Q}_{i} ( x , y , z ) = \frac{{r}_{i} η q}{{( 2 π )}^{3 / 2} {σ}_{xi} {σ}_{y} {σ}_{z}} exp ( - \frac{{x}^{2}}{2 {σ}_{xi}^{2}} - \frac{{y}^{2}}{2 {σ}_{y}^{2}} - \frac{{z}^{2}}{2 {σ}_{z}^{2}} ) \qquad ( 1 )$$

where the subscript i=1,2 denotes the two ellipsoids, one to the front and the other to the rear of the plane x=0, respectively. Each ellipsoid represents a two-dimensional Gaussian distribution on the top surface z=0 combined with a Gaussian distribution in the z-direction. The laser is assumed to scan in the positive x-direction. The width of the Gaussian in each direction is described by its standard deviation, σ. For fibre-laser processing, the 1/e² beam diameter d=4σ is well-established. Both the front and rear heat source ellipsoids described by equation (1) extend into the infinite volume in all directions, including for negative z values above the surface of the substrate on the plane z=0. Hence the total power absorbed in the infinite volume is given by:

$$η q = {r}_{1} η q + {r}_{2} η q i . e . {r}_{1} + {r}_{2} = 1 \qquad ( 2 )$$

where q is the laser power (in W), η is the absorptivity and rᵢ (a number between 0 and 1) is the fraction of the laser power in the front and rear ellipsoids. This relationship is consistent with the analytic calculation of the temperature distribution from an applied heat source: the total power is applied to the infinite volume and the subsequent integration limits the region of interest to the substrate in the semi-infinite volume below the plane z=0.

FIG. 2 shows the heat source of equation (1) for z≥0, i.e. within the semi-infinite volume of the work piece. The black outline indicates the ±2σ extent of both ellipsoids in all directions. The width of both ellipsoids is the same and assumed to be equal to the laser spot diameter 4σ_{y}=d. The length of the front ellipsoid is assumed to equal the laser spot radius, i.e. 2σₓ₁=d/2 or 2σₓ₁=2σ_{y}. The remaining properties of the source must be determined by calibration: the depth of both ellipsoids given by 2σ_{z}, the independent length of the rear ellipsoid defined by 2σₓ₂ and the absorptivity η. FIG. 2(a) shows the source for σₓ₂=4σₓ₁ and r₁=0.6. The red shading indicates a surface of constant power density, here taken to be the power density on the +20 boundary of the front ellipsoid. For the values chosen in FIG. 2(a), r₁/σₓ₁>r₂/σₓ₂ and so the power density on the ±2σ boundary of the front ellipsoid is greater than that for the rear ellipsoid: hence the surface of constant power density for the rear ellipsoid in the FIG. 2(a) is closer to origin.

To avoid specifying r₁, the source can be assumed as continuous on the plane x=0 as shown in FIG. 2(b), which requires r₁/σₓ₁=r₂/σₓ₂ from equation (2). However, it has been found that in many cases this continuous heat source does not reproduce the penetration observed experimentally in powder bed fusion. This is because as the rear ellipsoid length 2σₓ₂ increases the heat source continuity constraint requires r₂ to also increase, distributing an increased proportion of the laser power into the rear ellipsoid which decreases penetration at the front. Therefore, the heat source indicated in FIG. 2(a) is used and the choice of r₁ is discussed later. The discontinuity in power density on the plane x=0 emphasizes that the equivalent heat source is not an exact model of the physical source, but a representation of the heat input that will produce the desired temperature distribution at the experimental measurement positions for the IHCP fit. The temperature field produced by the heat source in FIG. 2(a) is continuous, as shown later.

The IHCP approach requires the response function Tₙ to be calculated at each position n using a direct conduction model for the equivalent heat source:

$$T ( x , y , z , t ) - {T}_{0} = 2 \frac{α}{k} \frac{q}{{π}^{3 / 2}} {\int }_{τ = 0}^{t} \frac{1}{\sqrt{{ϕ}_{y} {ϕ}_{z}}} exp ( - \frac{{( y - {y}^{′} )}^{2}}{{ϕ}_{y}} - \frac{{z}^{2}}{{ϕ}_{z}} ) \times ( \begin{matrix}\frac{{r}_{1}}{\sqrt{{ϕ}_{x 1}}} exp ( - \frac{{( x - {x}^{′} )}^{2}}{{ϕ}_{x 1}} ) [ 1 + erf ( \sqrt{\frac{2 {σ}_{x 1}^{2}}{4 α ( t - τ )}} \frac{( x - {x}^{′} )}{\sqrt{{ϕ}_{x 1}}} ) ] + \\ \frac{{r}_{2}}{\sqrt{{ϕ}_{x 2}}} exp ( - \frac{{( x - {x}^{′} )}^{2}}{{ϕ}_{x 2}} ) [ 1 - erf ( \sqrt{\frac{2 {σ}_{x 2}^{2}}{4 α ( t - τ )}} \frac{( x - {x}^{′} )}{\sqrt{{ϕ}_{x 2}}} ) ]\end{matrix} ) d τ \qquad ( 3 )$$

where ϕₓ₁=4α(t−τ)+2σₓ₁² etc., a is the thermal diffusivity (in m²/s) and k is the thermal conductivity (W/(mK)). T₀ is the initial temperature of the semi-infinite domain at t=0, and (x′,y′) is the position of the heat source on the surface z=0 at time t.

It is possible to obtain the well-known solution for a surface Gaussian heat source by setting r₁=r₂=0.5, σₓ₁=σₓ₂=σ_{y}=σ and σ_{z}=0 in equation (3) to obtain:

$$T ( x , y , z , t ) - {T}_{0} = 2 \frac{α}{k} \frac{q}{{π}^{3 / 2}} {\int }_{τ = 0}^{t} \frac{1}{\sqrt{4 α ( t - τ )}} \frac{1}{4 α ( t - τ ) + 2 {σ}^{2}} exp ( \begin{matrix}- \frac{\begin{matrix}{( x - {x}^{′} )}^{2} + \\ {( y - {y}^{′} )}^{2}\end{matrix}}{4 α ( t - τ ) + 2 {σ}^{2}} - \\ \frac{{z}^{2}}{4 α ( t - τ )}\end{matrix} ) d τ = \frac{α}{k} \frac{q}{4 {( π α )}^{3 / 2}} {\int }_{τ = 0}^{t} \frac{1}{{( t - τ )}^{3 / 2}} \frac{4 α ( t - τ )}{\begin{matrix}4 α ( t - τ ) + \\ 2 {σ}^{2}\end{matrix}} exp ( \begin{matrix}- \frac{\begin{matrix}{( x - {x}^{′} )}^{2} + \\ {( y - {y}^{′} )}^{2}\end{matrix}}{4 α ( t - τ ) + 2 {σ}^{2}} - \\ \frac{{z}^{2}}{4 α ( t - τ )}\end{matrix} ) dτ \qquad ( 4 )$$

Additionally, the temperature distribution for a point source is obtained by setting σ=0 in equation (5) to obtain:

$$T ( x , y , z , t ) - {T}_{0} = \frac{α}{k} \frac{q}{4 {( π α )}^{3 / 2}} {\int }_{τ = 0}^{t} \frac{1}{{( t - τ )}^{3 / 2}} exp ( - \frac{{( x - {x}^{′} )}^{2} + {( y - {y}^{′} )}^{2} + {z}^{2}}{4 α ( t - τ )} ) d τ \qquad ( 5 )$$

Equation (5) has an advantage of being integrable to produce a steady state, analytic solution for a point source.

$$( ξ , y , z ) - {T}_{0} = \frac{q}{2 π k} \frac{1}{r} exp ( - \frac{v}{2 α} ( r + ξ ) ) \qquad ( 6 )$$

where ξ=x−vt represents the quasi-stationary reference frame and r=\sqrt{x²+y²+z²}.

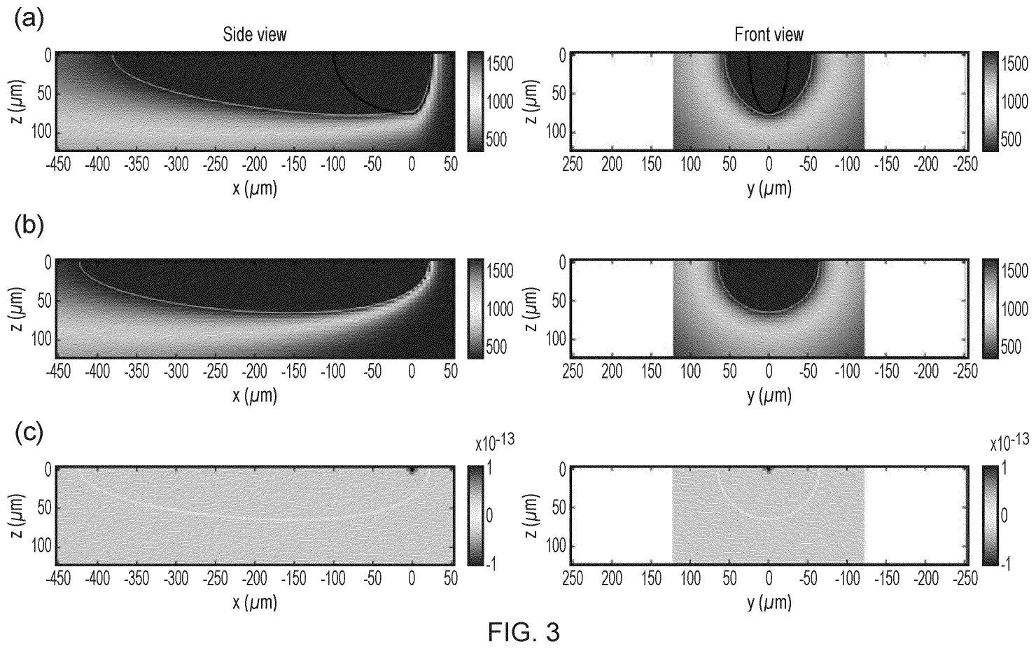

FIG. 3(a) shows the temperature distribution calculated using equation (3) over an integration time sufficient for the temperature to reach the steady state in the plotted volume. The source parameters are those given in FIG. 2(a) for d=4σ_{y}=50 μm and its ±2σ extent is indicated by a black line in both the side and front views. As noted in the above, conduction-only models do not give useful information inside the melt pool and so temperatures above the melting temperature, Tₘ, are capped at Tₘ in the plot. The calculated melt pool boundary, T=Tₘ, is indicated by the white line. The side view of the melt pool is taken on the plane y=0. The front view was obtained by taking the maximum temperature through all x values at each yz position: it is equivalent to the melt pool cross-section that would be recorded in a micrograph. All temperature distributions for the side and front views presented herein are calculated in this way. The material properties used in the calculation are the material properties for stainless steel of: α=7.11×10⁻⁶ m²/s, k=35.14 W/(m K) and Tₘ=1648 K. These values are used for all temperature calculations herein: the choice of values is discussed later.

FIG. 3(b) shows the temperature distribution again calculated using the semi-analytic solution of equation (3) but for the volumetric heat source parameters taken to convert it to a point source: i.e. r₁=r₂=0.5 and σₓ₁=σₓ₂=σ_{y}=σ_{z}=0. The integration time was sufficient for the temperature to reach the steady state in the plotted volume. FIG. 3(c) shows the difference between the temperature of FIG. 3(b) and the analytic steady state temperature for a point source given by equation (6). The difference is essentially zero everywhere, at the level of the numerical precision of the calculation. The largest difference occurs immediately under the point source due to the singularity in the analytic solution: its magnitude is inconsequential and anyway occurs within the melt pool where the temperature is not of interest. The exact agreement between the semi-analytic and analytic solutions shows that equations (3) to (6) are consistent and that the numerical integration is performed accurately. The integration was performed in Matlab with the integral( ) function that uses adaptive quadrature to define sub-intervals to accommodate automatically the large variation of gradients in the integral.

For both FIGS. 3a and 3b, laser power q=50 W and scan speed v=0.5 m/s.

FIG. 3 demonstrates that the double ellipsoid source can replicate an increase in penetration at the front of the melt pool compared to a point source, which reflects the impact of the vapour depression. For the same laser power and scan speed, it reduces the melt pool width and length on the top surface compared to a point source because the heat input is distributed deeper into the material by the source depth 2σ_{z}.

### EXAMPLE

Single-track experiments were performed in an open-architecture laser PBF system. Island scan experiments were performed in the system with a flow straightener that provides a laminar flow of Ar gas across the powder bed at speeds of approximately 2.1 m/s. In all experiments, a single-mode fibre laser (SPI 400W continuous wave, 1070 nm) was used, focused with a 4Dσ diameter of 50 μm.

The single-track experiments were performed on the substrate only, i.e. without powder, that was made of stainless steel SS304L with a surface roughened by manual, circular rubbing with P400 sandpaper. Single tracks of length 20 mm were recorded at a laser power of 200 W for various scan speeds, to take the melt pool cross-section from the conduction mode (1.8 m/s) through to the keyhole mode (0.5 m/s). A delay of approximately three minutes was set between scanning each track to enable the substrate to return to ambient temperature, monitored with a K-type thermocouple fixed to its rear surface. To produce the micrographs, specimens were diamond cut perpendicular to the scan direction and machine-polished using silicon carbide grinding papers (240 to 2000 grits) and a cashmere cloth. The samples were then electrolytically etched at 10V, 5A in a solution of ratio 10:1, de-anodised water to oxalic acid. The melt pool solidification boundaries were imaged on an Alicona Infinite Focus with a 20× objective.

Island-scan experiments were performed for both the substrate only and for the substrate covered with a powder layer. The substrate was again stainless steel SS304L and the powder comprised a 50 μm thick layer of gas-atomised stainless steel SS316L with particle diameters in the range of 15 to 45 μm and a mean diameter of 30 μm. Islands of 5×5 mm² were recorded at two laser powers (100 and 200 W) and scan speeds in the range 0.4 to 1.0 m/s. The hatch spacing was 80 μm and the laser-off time was 1 ms between adjacent tracks in the island. Specimens were sectioned perpendicular to the scan direction at the centre of the island, followed by the same polishing and etching process described previously. The coupon was again allowed to cool to ambient temperature between island scans in order to eliminate cumulative thermal effects.

### Results

### Single-Track Experiments

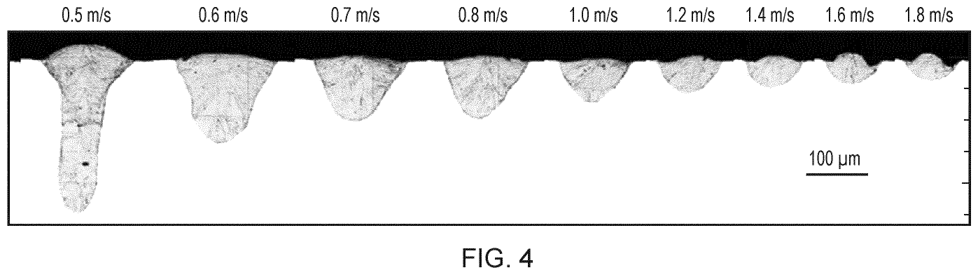

FIG. 4 shows the melt pool solidification boundaries obtained from the micrographs for the single-track experiments. Laser power q=200 W and d=50 μm at the scan speed indicated. Each boundary was manually sampled at 33 positions. The cross-section at v=0.5 m/s was excluded because it is clearly in the unstable keyhole mode: the small black regions are pores in the melt pool. The temperature at these yz-points on the melt pool boundary corresponds the melting point Tₘ for stainless steel. These experimental temperature measurements Tₙ^{m} were used in equation (1) to minimise the objective function by adjusting the temperature calculated using the volumetric heat source, Tₙ, from equation (3) via adjustments to the three parameters that describe the heat source, namely the absorptivity η and its depth 2σ_{z} and rear length 2σₓ₂. The weighting function wₙ^{T} on these experimental points was set equal to 1 at the two edges and centre of each melt pool: the weighting at intermediate points in each half of the melt pool followed a cosine curve. This approach emphasized the melt pool width and depth on the fit parameters and reduced the influence of intermediate points. The melt pool boundary is constantly subjected to small perturbations and so we aim to capture the main features rather than attempting to achieve an exact fit to the profile.

FIG. 3 demonstrated that increasing the source depth 2σ_{z} whilst maintaining other parameters constant reduces the length of the melt pool. In practice, it is expected that Marangoni convection and the momentum imparted by the recoil pressure lengthen the melt pool. Therefore, an additional point was included in the fit for the rear of the melt pool on the top surface: this prevents the melt pool length being reduced unrealistically due to an increase in source depth 2σ_{z} when fitting to a melt pool cross-section with increased penetration. The melt pool length was not measured during these experiments. Instead, the temperature at a point corresponding to the length of the melt pool calculated for a Gaussian source with the same absorbed laser power, scan speed and spot diameter was included as an additional point in the objective function. The absorbed laser power included the current value of the absorptivity η during each iteration of the fit. The weighting function wₙ^{T} on this additional point was set equal to the sum of all the weighting factors used for the melt pool boundary points, to give the length and boundary residuals similar importance in the final fit. Incorporating experimental points from the top surface of the melt pool is discussed later, but it does not affect the IHCP methodology proposed here.

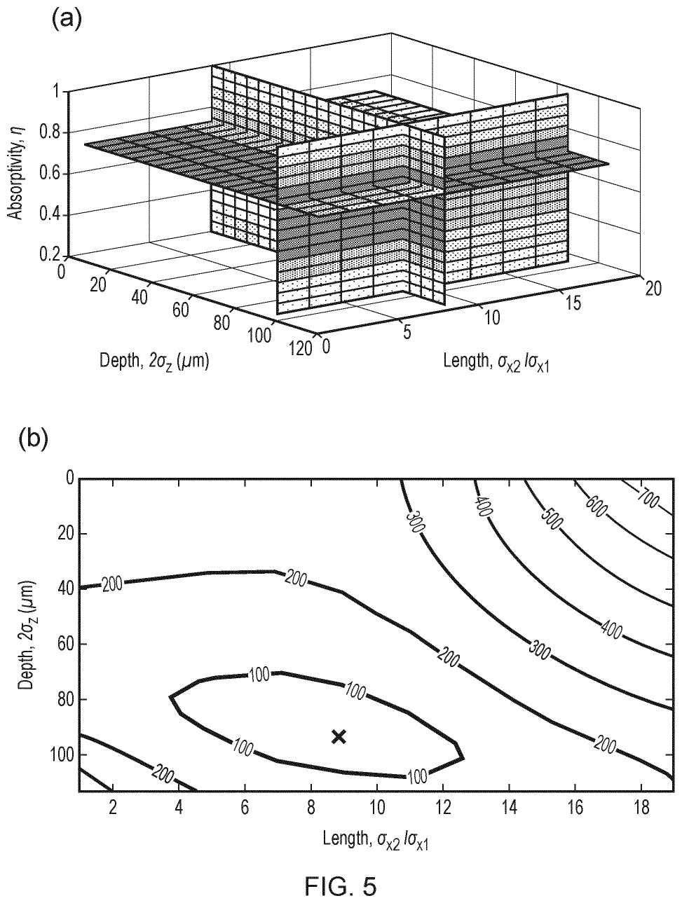

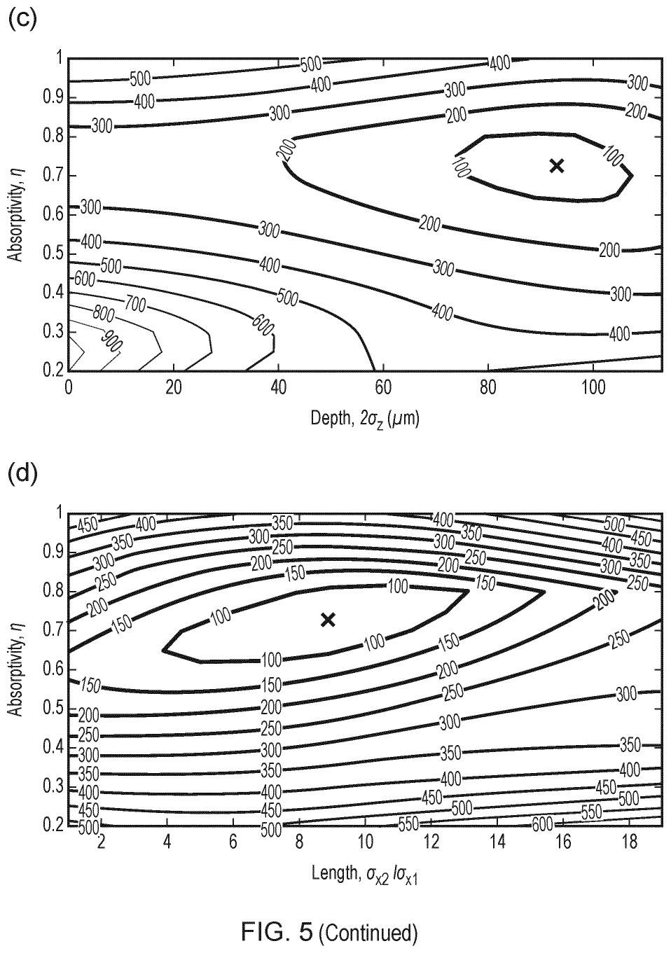

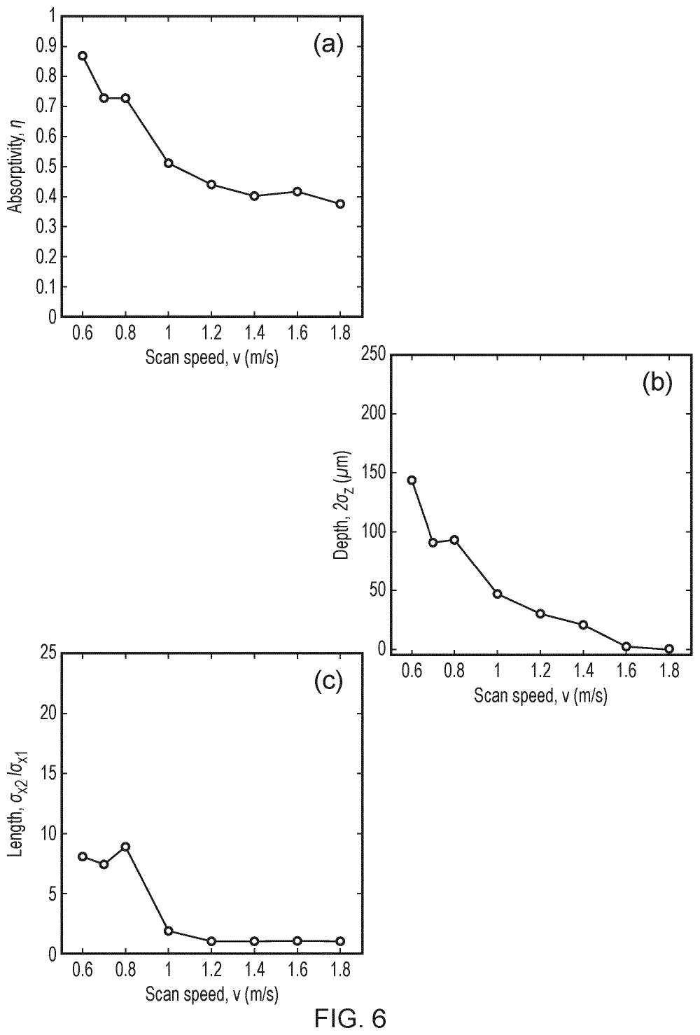

For each melt pool, equation (1) was minimised over the 34 points (33 cross-section, 1 length) to determine the heat source parameters η, 2σ_{z}, and 2σₓ₂, i.e. the absorptivity and the depth and rear length of the heat source. No additional regularization terms were required due to the constraints inherent in the volumetric heat source of equation (3). The diameter of the heat source was fixed to match the laser spot diameter, d=4σ_{y}=50 μm and the length of the front ellipsoid was set equal the laser spot radius, d/2=2σₓ₁=25 μm. The ratio of laser power between the front and rear ellipsoids was set at r₁=0.6, which is discussed later. Minimisation was achieved in Matlab using the fminsearch( ) function. The initial condition for the minimisation represented a perfectly absorbed circular, surface Gaussian source that matched the laser spot diameter, i.e. η=1, 2σ_{z}=0 and 2σₓ₂=25 μm. It is convenient to express the rear length parameter 2σₓ₂ in terms of the ratio σₓ₂/σₓ₁, because the front length 2σx1=25 μm remains fixed during the fit: hence σₓ₂/σₓ₁=1 was the initial condition for the minimisation. FIG. 5(a) shows an example of the objective function F(η, 2σz, 2σx2) calculated over a three-dimensional volume of the three fit parameters. Calculating the objective function over this volume is not necessary to perform the minimisation: it is used here to demonstrate that the objective function is well-behaved and that a unique solution could be identified. FIGS. 5(b)-(d) show the objective function on the three orthogonal planes in FIG. 5(a) that intersect at the minimum. A unique solution was found for all the experiments reported.

FIG. 6 shows the three fitted heat source parameters determined at each laser scan speed. FIG. 6(a) shows that the fitted absorptivity η increases from ˜0.4 at high speeds in the conduction melt pool mode to ˜0.8 at lower speeds in the transition mode, which is consistent with experimental measurements. The absorptivity increases due to an increase in the depth of the stable vapour depression, which increases the depth-to-width aspect ratio of the melt pool. Hence the depth of the heat source 2σ_{z} is approximately zero at high speeds in the conduction mode, corresponding to a surface Gaussian, FIG. 6(b). The source depth increases as the speed decreases which corresponds to increased penetration at the front of the melt pool. Similarly, FIG. 6(c) shows that the length of the rear ellipsoid 2σₓ₂ at high scan speeds in the conduction mode also corresponds to a circular Gaussian source with the ratio σₓ₂/σₓ₁=1. The rear ellipsoid length increases at lower speeds, in order to maintain the melt pool length as the source depth 2σ_{z} increases.

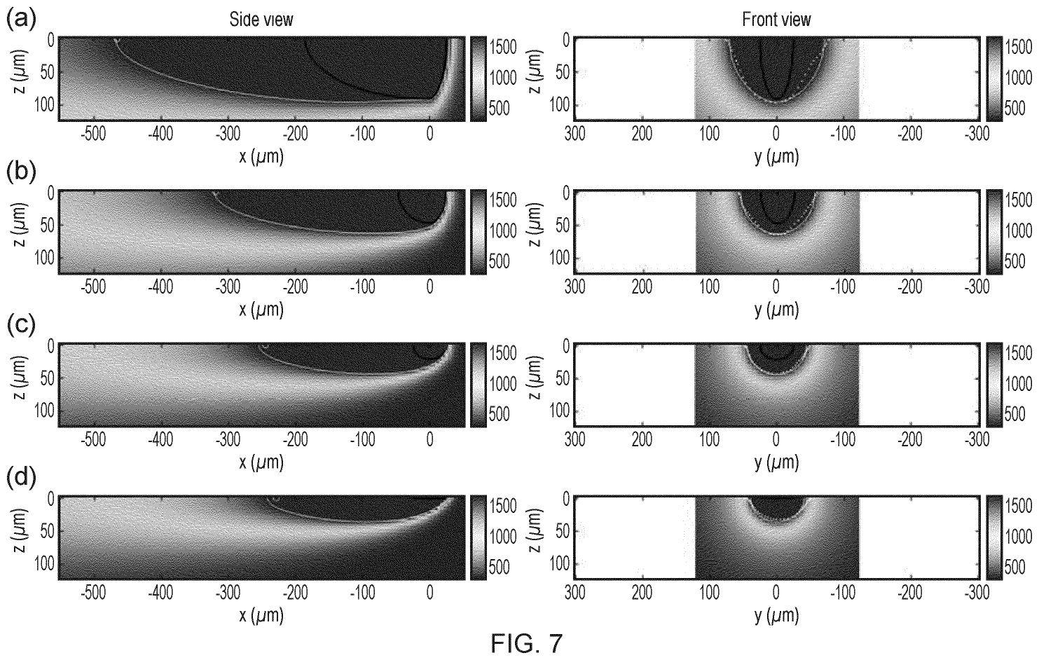

FIG. 7 shows melt pool profiles calculated from the heat source with the fitted parameters at a sample of the laser scan speeds. As before, temperatures are capped at the melting point Tₘ, the white lines indicate the melt pool boundary T=Tₘ and the black lines show the ±2σ extent of the volumetric heat source. The 33 experimental melt pool boundary points taken from FIG. 4 and used to fit the heat source in each case are included in the front view as white points. The fitted heat source predicts a melt pool boundary that is in good agreement with the experimental points. The additional point used in the fit for the target melt pool length on the top surface is included as a white circle in the side view. The IHCP fitting methodology was the same for all laser scan speeds and is seen to manage the continuum between the conduction and transition melt pool mode profiles. The increased penetration at the front of the melt pool in the side view is consistent with recent x-ray images.

### Island Scan Experiments

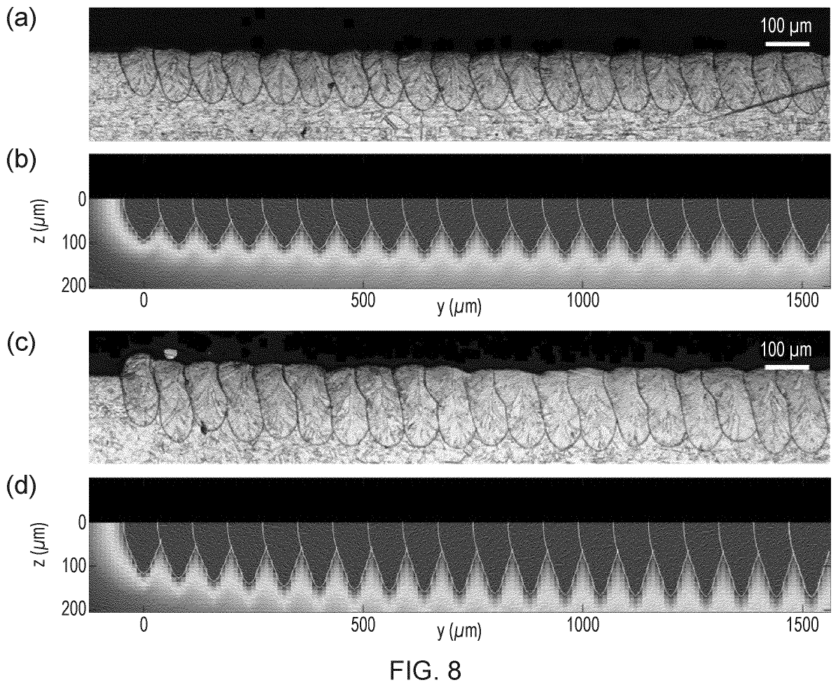

FIG. 8(a) shows an example micrograph recorded for the substrate only, and FIG. 8(c) with the powder layer. The first track is on the left of both images, with the laser scanning in alternate directions in each subsequent track. The first 20 tracks from the full 5×5 mm² island are shown. The accumulation of heat during the island scan is observed from the increasing cross-sectional area of later tracks. The form of each track along the island is generally the same, although there are small differences in the exact shape due to the constant fluctuations in melt boundary, as observed by x-ray imaging. With powder, small variations in the melt pool depth and shape are even more noticeable than for the substrate only, due to fluctuations in the absorbed laser power caused by the powder particle motion in the powder bed and above it. The bead of accumulated powder for the first track is larger than for subsequent tracks because powder can be entrained from both sides of the melt pool.

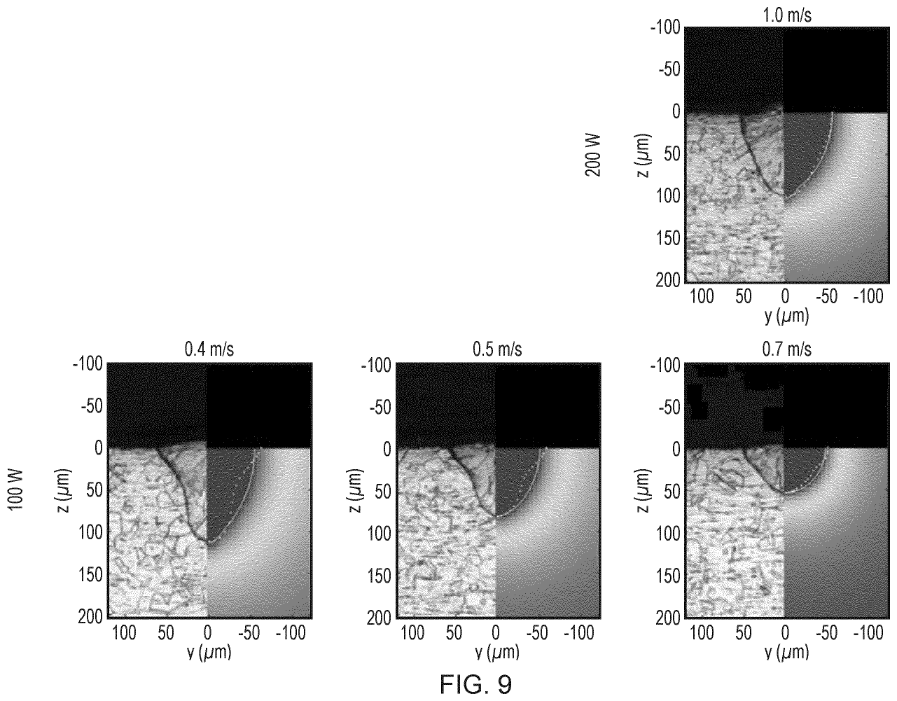

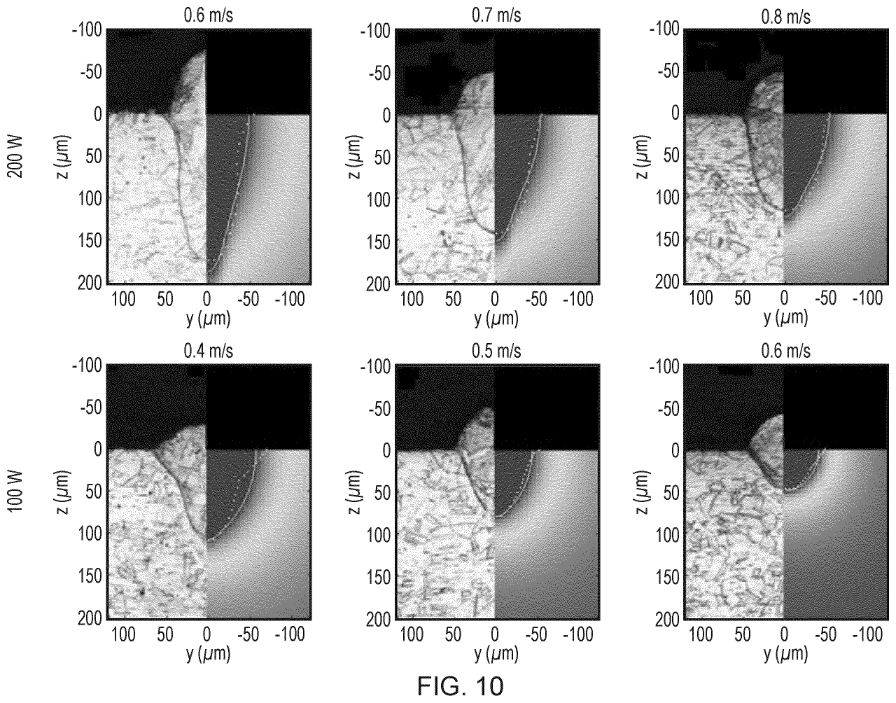

FIG. 9 shows the results for all the island scan experiments for the substrate only, and FIG. 10 results for the island scan experiments with powder. The left half of each image shows the micrograph of the first track of each island. The melt pool boundary position was sampled at 17 points, which are indicated as white points in the right half of each image, reflected in the line y=0. The right half of each image also shows the front view temperature distribution calculated with the fitted heat source parameters. The emphasis of the fit (through the choice of weighting function wₙ^{T}) was to the width and depth of the melt pool boundary, rather than to intermediate ‘wine glass’ features at low laser power and scan speed (e.g. FIG. 10, 100 W at 0.4 m/s) and excessive penetration at high power (e.g. FIG. 10, 200 W at 0.6 m/s); neither profile is generally preferred for laser powder bed fusion. Transition melt pools profiles, e.g. FIG. 10, 200 W at 0.8 m/s; and 100 W at 0.5 m/s, are generally preferred, because they increase re-melting efficiency compared to a shallower conduction melt pool mode, e.g. FIG. 10, 100 W at 0.6 m/s.

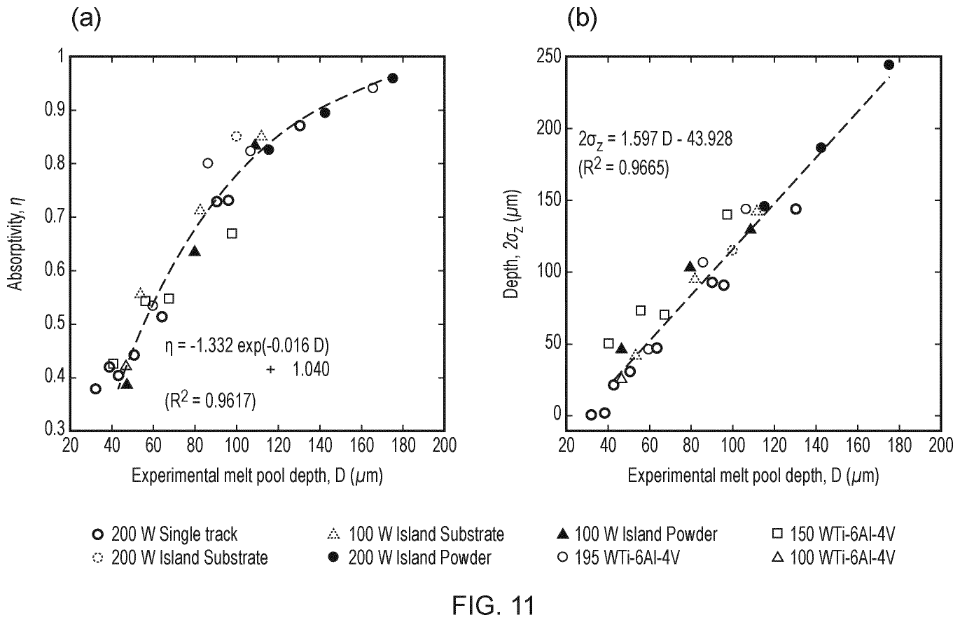

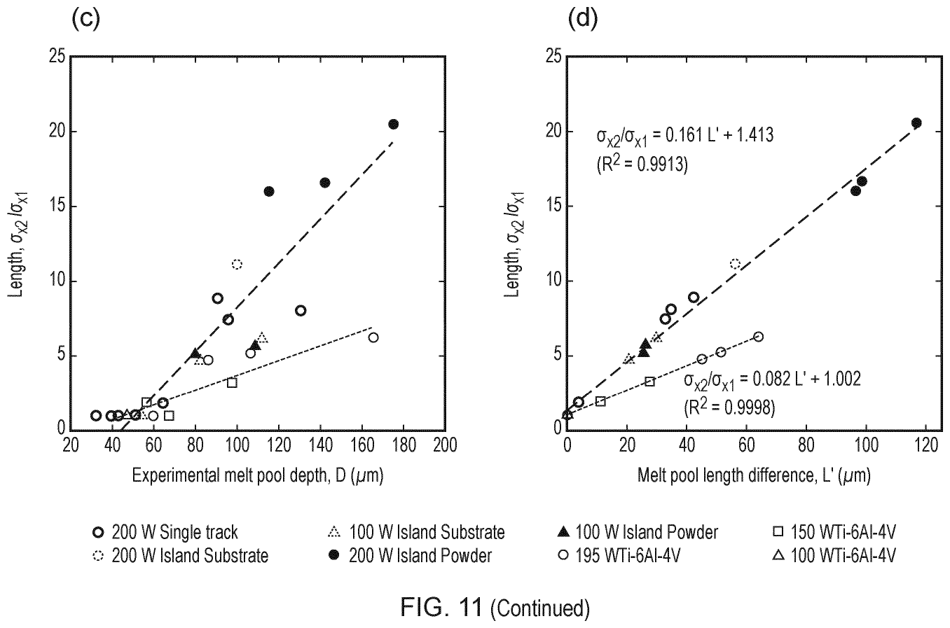

The three fitted heat source parameters for all the islands scans are shown in FIG. 11(a)-(c), plotted against the experimental melt pool depth, D. The fitted parameters for the single-track experiments from FIG. 5 are also included. The absorptivity η increases as the laser scan speed decreases at a given laser power, i.e. as the melt pool depth increases, FIG. 11(a). It is larger than 0.8 for some of the 200 W measurements with powder, which have a melt pool depth that is too far into the transition regime towards a fully formed keyhole than desired for pore-free laser powder be fusion. The trend line in the graph considers all the stainless steel results presented in this paper, i.e. both the single-track and island scans (substrate only and with powder) at all laser powers. The fitted heat source depth 2σ_{z} varies linearly with the experimentally measured melt pool depth, FIG. 11(b). However, there is no direct relationship between the heat source rear length 2σₓ₂ and the melt pool depth, FIG. 11(c). A linear trend line is included to indicate the general trend: for shallow melt pools in the conduction regime, the heat source tends towards the ideal surface Gaussian distribution with σₓ₂/σₓ₁=1 and 2σ_{z}=0; as the melt pool depth increases and the absorbed power increases, the heat source rear length 2σₓ₂ must increase to achieve the target melt pool length. FIG. 11(d) shows the change in melt pool length L′ between the melt pool calculated with the fitted parameters including the heat source rear length 2σₓ₂ given by σₓ₂/σₓ₁ in FIG. 11(c), and that calculated by setting σₓ₂/σₓ₁=1 and leaving the other fit parameters unchanged. There is a direct relationship between the increase in melt pool length and the heat source rear length 2σₓ₂. This increase can be applied irrespective of how the target melt pool length is determined, e.g. calculated (as used here) or from an experimental measurement. Overall, the powder layer was observed to have very little effect on the melt pool profile below the surface, which corresponds to experimental observations of the laser powder bed fusion process where the laser interacts directly with the melt pool and the powder tumbles or is entrained into the molten track.

The heat source fit parameters for absorptivity η and depth 2σ_{z} together influence the shape of the melt pool cross-section, as indicated by their well-behaved relationship with the melt pool depth across the range of laser powers and scan speeds, FIGS. 11(a) and (b). Increasing the absorptivity η, whilst holding all other parameters constant, increases the melt pool cross-sectional area but leaves its depth-to-width aspect ratio relatively unchanged. On the other hand, increasing the heat source depth 2σ_{z}, whilst holding all other parameters constant, increases this melt pool aspect ratio. FIG. 11(d) shows that increasing the heat source rear length 2σₓ₂ increases the length of the melt pool: it produces very little change in the melt pool cross-section profile. These observations from FIG. 11 provide insight into properties of the volumetric heat source. For a given process setting, the melt pool depth would need to be measured experimentally before the source parameters could be determined. Thus, more information is needed if the heat source parameters are to be interpolated at intermediate process settings not used in the calibration experiments.

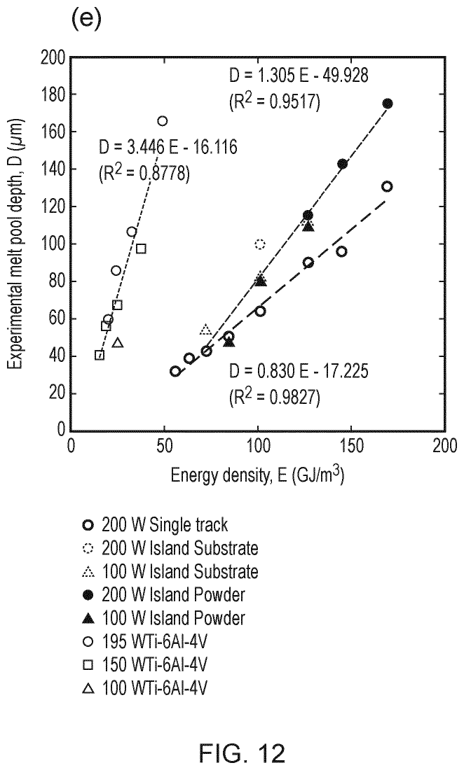

The energy density, E=φ/v, where φ is the power density 4q/d², can be used to predict the stability of the vapour depression at the process settings typically used in laser powder bed fusion. In particular, a linear relationship between the vapour depression depth and the energy density was observed. This energy density depends on the process settings (q, v and d) only and does not include the powder layer thickness or hatch spacing. FIG. 12 plots the experimentally measured melt pool depth against energy density for all the stainless steel experiments reported here. The single-track experiments were performed in a modified system to the island scan results, resulting in a different linear fit in both cases. The energy density therefore enables the melt pool depth to be predicted, FIG. 12, from which the absorptivity η and heat source depth 2σ_{z} can be determined for any intermediate process settings between those for which experiments have bene carried out, FIGS. 11(a) and (b); the heat sources rear length 2σₓ₂ is then chosen to increase the calculated melt pool length to the target value, FIG. 11(d). Equally, intermediate process settings required to produce a desired (user specified) melt pool depth/dimension can be estimated using the model. Hence, a desired predictive capability for a range of laser powder bed fusion settings based on a smaller set of calibration experiments can be achieved.

The IHCP calibration described here provides a systematic approach to incorporate volumetric heat sources into the semi-analytic and numerical conduction-only models. Via calibration from experimental data, the heat source indirectly incorporates more complex physical phenomena but at a significantly reduced computational cost, enabling realistic effects such as absorptivity and remelt depth to be included for process planning. The source calibration also incorporates machine-specific settings that affect the laser powder bed fusion process. For example, FIG. 12 showed that the melt pool depth was greater at a given line energy in the experimental system used to record the island scans than for the single-track experiments: differences between the systems included a stronger shielding gas cross-flow for the island scans that improved the removal of process fume. That increased depth at a given line energy results in different heat source parameters via FIG. 11. Hence the calibration approach can be used as a systematic method to characterize individual laser powder bed fusion systems and to quantify the inevitable drift in their set-up that occurs over time.

FIG. 12 incorporates the melt pool depth taken from Ti-6Al-4V melt pool cross sections recorded in a commercial EOS M270 PBF system for a range of laser powers and scan speeds. It is believed that only the melt pool depth and length need to be calibrated against energy density for other materials, and that relation between the fit parameters η and 2σ_{z} obtained here for stainless steel and Ti-6Al-4V can be applied.

Incorporating a melt pool length into the IHCP methodology is beneficial: without it, an increase in heat source depth 2σ_{z} for transition melt pools shortens the melt pool length, FIG. 3. The melt pool length calculated for a Gaussian source (for the same absorbed laser power, scan speed and spot diameter) was used for both the stainless steel and Ti-6Al-4V results. In practice, the experimental melt pool length can be longer: numerical modelling suggests that including the latent heat can increase the melt pool length by up to 34% compared to conduction-only.

Alternatively, an experimentally measured melt pool length recorded under the same conditions as the melt pool cross sections could be used. Indeed, it would also be feasible to incorporate experimental points from other positions around the melt pool boundary on the top surface. FIG. 11(d) shows that an increase in the target melt pool length is directly related to the heat source rear length 2σₓ₂, with very little effect on the absorptivity η and heat source 2σ_{z} (which control the melt pool size and aspect ratio). In the end, whatever method is used to determine the target melt pool length, it can be incorporated into the IHCP methodology presented herein.

Single track melt pool cross-sections are often used to infer powder bed fusion process settings, for example the Ti-6Al-4V results. However, the process evolves from the first track during an island scan, due to the temperature rise and an adjacent bead of the previous track; the melt pool depth of adjacent tracks in an island scan can increase due to heat accumulation from the previous exposures. Similarly, the process evolves between layers, particularly over the first ˜10 layers as the steady state powder layer thickness is established. The calibration approach can be extended to obtain heat source fit parameters that describe the evolution of these different aspects of the process. For example, FIGS. 8(b) and (d) show the simulated melt pool profile for subsequent tracks in the island scans without calibrating each track individually. In each case, the heat source calibrated from the first track in FIGS. 8 and 9, respectively, was used but the source depth 2σ_{z} was increased for each track in proportion to the experimentally observed depth, which can be related in turn to the temperature increase in the workpiece.

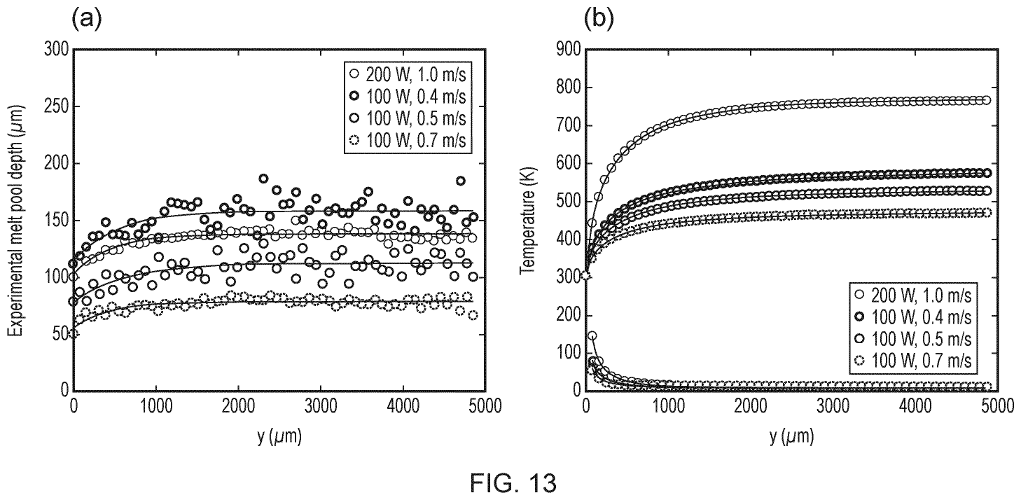

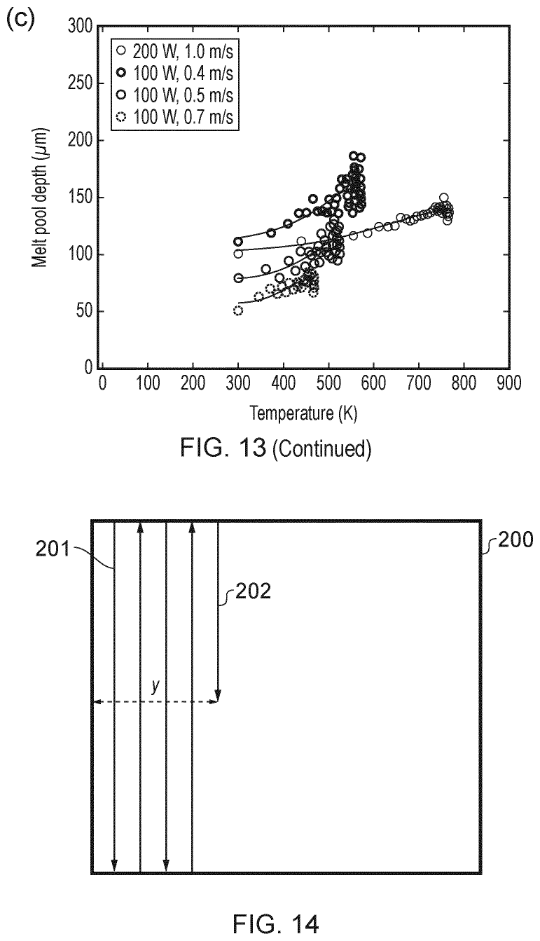

An initial temperature of the powder bed may be calculated based on a modelling of heat accumulation as the scans of scan paths, such as hatch lines, progress. FIG. 13a shows the experimentally measured melt pool depth against distance, y, (illustrated in FIG. 14) from an edge of an island 200, wherein the first hatch line 201 is carried out at the edge of the island 200 and then subsequent hatch lines 202 are carried out adjacent to the last formed hatch line. The distance y is in a direction perpendicular to the hatch direction. As can be seen from the graph, the melt pool depth steadily increases from an initial depth in the first hatch line until reaching a steady state.

FIG. 13b shows a initial temperature of the powder bed at the point of exposure with the distance y predicted by a heat accumulation model. As can be seen, the initial temperature steadily increases from the first hatch line until reaching a steady state.

FIG. 13c combines the data provided in FIGS. 13a and 13b to provide a relationship between melt pool depth and initial temperature for each set of scan parameters. Such a relationship may be used to modify the melt pool depth predicted to occur for a set of scan parameters as the initial temperature changes due to heat accumulation from previous exposures. To obtain a desired melt pool depth, the scan parameters may be changed based on predictions of the initial temperature from a heat accumulation model and the determined correlation with melt pool depth to ensure that the melt pool depth stays within an acceptable range of the desired melt pool depth. Accordingly, a model of heat accumulation in the powder bed may be used to feed initial temperatures into a volumetric heat source model in order to determine scan parameters based on the desired property of the melt pool.

With regard to FIG. 1, it was stated that it is better to fix the proportion r₁ of laser power in the front ellipsoid in order to reproduce the increased penetration at the front of the melt pool. Heat source parameter fits were successfully performed for fixed vales of r₁ in the range 0.6≤r₁≤0.9 for the melt pool cross sections reported here. Changing r₁ produces only a small change in the fitted source parameters, and the resulting melt pool shapes are almost identical. Increasing r₁: decreases the fitted absorptivity η and heat source depth 2σ_{z} because more power is available at the front of the melt pool to achieve the required penetration; increases the heat source rear length 2σₓ₂ to compensate for reduced power in the rear ellipsoid in order to achieve the target melt pool length. r₁=0.6 was chosen for all the results presented here to minimise the heat source rear length 2σₓ₂, because it is the least ‘physical’ aspect of the equivalent heat source compared to an actual focused laser beam. It was found that r₁≤0.5 did not generally produce the required increased penetration at the front of the melt pool and the fit residuals were larger.

The second ‘indirect’ fit parameter is the choice of temperature, Tₚᵣₒₚ, at which the temperature-dependent material properties are calculated. The effect of changing the material properties on the calculated melt pool can be understood by considering the steady state temperature distribution for a scanning point source, equation (6). The first term q/(2πkr) is the hemi-spherical, steady state temperature distribution for a stationary point source. Reducing the thermal conductivity k increases the melt pool radius in proportion to I/k. On the top surface, the rear position of the melt pool for the scanning laser beam equals this radius: it is not affected by the laser scan speed, v, because y=z=0 on the top surface centre-line and the exponential term does not contribute where ξ=−r. Elsewhere on the top surface, away from the melt pool centre line, reducing the thermal diffusivity a (or increasing v) reduces the width to produce a narrower melt pool.

The material properties for SS316L calculated at the melting temperature were used, i.e. Tₚᵣₒₚ=Tm=1648 K for all the stainless steel results presented here. We chose the solidus rather than the liquidus temperature (1673 K) because it was not possible to distinguish the two boundaries in the micrographs, and it is therefore representative of the temperature of the material immediately surrounding the measured melt pool boundary. The small difference in material properties between the two temperatures does not have a significant effect on either the calculated temperature distribution or the fitted heat source parameters. Even a significantly different Tₚᵣₒₚ does not change the fitted heat source parameters significantly: The heat source parameter fits at Tₚᵣₒₚ=300 K have been successfully performed for all the data sets. At this lower Tₚᵣₒₚ, both the thermal conductivity k and the thermal diffusivity a decrease for SS316L. As noted in the preceding paragraph, a reduction in k increases the melt pool length. It also increases the melt pool width, because the increase due to k offsets the smaller decrease due to a. Decreasing Tₚᵣₒₚ: decreases the fitted absorptivity η and heat source depth 2σ_{z} because less power is required to calculate the same melt pool cross section; increases the heat source rear length 2σₓ₂ to accommodate the increased melt pool length. A higher Tₚᵣₒₚ is chosen to minimise the heat source rear length 2σₓ₂, again because it is the least ‘physical’ aspect of the equivalent heat source compared to an actual focused laser beam.

A systematic IHCP method to calibrate volumetric heat sources for modelling laser powder bed fusion has been introduced and shown to work for both conduction and transition melt pool modes. Clear relationships have been found between both the heat source absorptivity η and depth 2σ_{z} and the experimental melt pool depth, over the full range of laser parameters tested for both the substrate only and with a powder layer. Additionally, a linear relationship between the energy density and the melt pool depth was reported, enabling the η and 2σ_{z} to be determined at intermediate process settings or process settings to be determined for intermediate values of η and 2σ_{z} between a smaller number of calibration experiments. The linear relationship found between the increase in melt pool length and the heat source rear length 2σₓ₂ can be used to achieve the target melt pool length.

The melt pool profiles calculated from the fitted heat source produce the shape observed in recent experiments, including increased penetration at the front due to the vapour depression under the laser spot at higher energy densities, but at significantly reduced computational cost. The heat sources calibrated from the first track of island scans were applied successfully to replicate the melt pool evolution in the presence of heat accumulation from adjacent tracks. The calibration approach presented enables experimentally representative heat sources to be incorporated into conduction-only semi-analytic and numerical models for improved build planning.

It will be understood that alterations and modifications to the above-described embodiments may be made without departing from the invention as defined herein. For example, other volumetric shapes could be used for the equivalent volumetric heat source. An equivalent volumetric heat source may be defined by front and rear volumetric elements, one or both of which are not segments of ellipsoids.

1. A method of generating scan parameters for a powder bed fusion additive manufacturing process, the method comprising receiving at least one desired property of a material modified zone, the material modified zone formed by melting material and/or changing a microstructure of the material through an exposure of a powder bed to an energy beam, and determining the scan parameters for the energy beam estimated by a powder bed fusion model to result in a material modified zone having a property corresponding to the at least one desired property.

2. A method according to claim 1, wherein the material modified zone is a melt pool.

3. A method according to claim 2, wherein the at least one desired property comprises a melt pool dimension.

4. The method according to claim 1 comprising determining scan parameters estimated by a powder bed fusion model to result in a melt pool in a transition mode.

5. A method according to claim 1, wherein the powder bed fusion model comprises a look-up table or function that associates the at least one property to one or more scan parameters.

6. A method according to claim 5, wherein the look-up table or function comprises or defines intermediate values extrapolated from measured properties of material modified zones for known scan parameters.

7. A method according to claim 5, wherein the look-up table or function associates a single value for the property to a plurality of different scan parameters based on an initial temperature of the material.

8. A method according to claim 1, wherein the scan parameters are determined from an energy beam density determined from resolving the powder bed fusion model for the desired property.

9. A method according to claim 1, wherein the powder bed fusion model is a heat conduction-only model.

10. A method according to claim 1, wherein the powder bed fusion model takes into account an initial temperature of the powder when exposed to the energy beam.

11. A method according to claim 10, wherein the powder bed fusion model determines the initial temperature for each exposure point based on a location and time of previous exposures of the powder to the energy beam.

12. A method according to claim 1, wherein resolving the powder bed fusion model comprises using an equivalent volumetric heat source having dimensions corresponding to the at least one desired melt pool dimension to estimate a heat input that would give such a volumetric heat source.

13. A method of manufacturing a part comprising building the part using powder bed fusion with scan parameters determined using a method according to claim 1.

14. A data carrier having instruction thereon, wherein when the instructions are executed by a processor of a powder bed fusion additive manufacturing apparatus, the processor is caused to control the powder bed fusion additive manufacturing apparatus carry out the method of claim 13.

15. A method of generating a look-up table or function for use in the method of claim 1 comprising receiving, for each of a plurality of material modified zones formed by melting material and/or changing a microstructure of the material through exposures of material to an energy beam, a measured or numerically calculated property of the material modified zone, each material modified zone generated using a different set of scan parameters; calibrating parameters of a powder bed fusion model using measured or numerically calculated properties to provide a calibrated powder bed fusion model; and generating the look-up table or function based on the calibrated powder bed fusion model.

16. A method according to claim 15, comprising using an inverse heat conduction problem approach to calibrate the powder bed fusion model.

17. A method according to claim 15, wherein the parameters of the powder bed fusion model describe an equivalent heat source used in the powder bed fusion model to represent the melt pool.

18. A method according to claim 15, wherein the equivalent volumetric heat source is defined by segments of two curved three-dimensional shapes.

19. A method according to claim 18, wherein the equivalent volumetric heat source comprises a front segment modelling a front of the material modified zone in a scan direction and a rear segment modelling a rear of the material modified zone in the scan direction.

20. A method according to claim 19, wherein the front segment comprises a planar top face, a planar rear face and a continuous curved front face extending from an edge of the planar top face to an edge of the planar rear face; the rear segment comprises a planar top face, a planar front face and a continuous curved rear face extending from an edge of the planar top face to an edge of the planar front face, further wherein the rear face of the front segment and the front face of the rear segment are coincident and the curved faces of the two segments are non-continuous at a boundary between the two segments.

21. A method according to claim 15, wherein generating the look-up table or function based on the calibrated powder bed fusion model comprises interpolating from values provided by the powder bed fusion model for the measured or numerically calculated property, values for intermediate properties of the material modified zone.

22. A method according to claim 15, comprising solidifying material using powder bed fusion of a material, material solidified at different points using the different sets of scan parameters and measuring properties of the solidified material.

23. A method of checking a powder bed fusion process or a powder bed fusion apparatus that carries out the powder bed fusion process comprising receiving a measured property of a material modified zone formed by melting material and/or changing a microstructure of the material through exposures of material to an energy beam and determining whether the powder bed fusion process or a powder bed fusion apparatus has changed by comparing the measured property to a property predicted by a powder bed fusion model calibrated using measurements obtained from a previous powder bed fusion process.

24. A data carrier having instruction thereon, wherein when the instructions are executed by a processor, the processor is caused to carry out the method of claim 1.

25. Apparatus comprising a processor arranged to carry out the method of claim 1.
